(19) United States
(12) Patent Application Publication
(10) Pub. No.: US 2018/0253321 A1
(43) Pub. Date: Sep. 6, 2018

(54) AUTOMATED ASSISTANCE

(71) Applicant: Google Inc., Mountain View, CA (US)

(72) Inventors: Johnny Chen, Mountain View, CA (US); Thomas L. Dean, Los Altos Hills, CA (US); Sudeep Gandhe, Sunnyvale, CA (US); Gabriel Schine, Menlo Park, CA (US); Qiangfeng Peter Lau, Sunnyvale, CA (US)

(21) Appl. No.: 14/447,756

(22) Filed: Jul. 31, 2014

(51) Int. Cl. G06F 9/44; G06F 3/0482; G06F 3/0484; G06F 3/0488; G06F 3/16

(52) U.S. Cl. CPC G06F 9/4446; G06F 3/0482; G06F 3/167; G06F 3/0488; G06F 3/04842

(57) ABSTRACT

Methods, systems, and apparatus, including computer programs encoded on computer storage media, for determining user frustration and assisting the user in response. One of the methods includes receiving data from one or more sensors of a mobile device, determining, from the received data, that a user of the mobile device is having difficulty causing the mobile device to perform an action, determining the action the user is trying to cause the mobile device to perform using a state of the mobile device, and generating assistance data to cause the mobile device to perform the action.

### BACKGROUND

This specification relates to detecting user difficulty in causing a mobile device to perform an action.

A computer-implemented agent may interact with a user to provide the user with an interface for features of a device on which the computer-implemented agent executes or with which the computer-implemented agent is associated. For example, a computer implemented agent may execute on a mobile device, receive voice input from a user, and execute one or more actions in response to the voice input, such as retrieving search results responsive to the voice input and providing the search results to the user.

### SUMMARY

In general, one innovative aspect of the subject matter described in this specification can be embodied in methods that include the actions of receiving data from one or more sensors of a mobile device, determining, from the received data, that a user of the mobile device is having difficulty causing the mobile device to perform an action, determining the action the user is trying to cause the mobile device to perform using a state of the mobile device, and generating assistance data to cause the mobile device to perform the action. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Determining that the user of the mobile device is having difficulty causing the mobile device to perform an action may include receiving a digital representation of speech encoding an utterance, and determining, using a user model for the mobile device, that the utterance is indicative of an inability to cause the mobile device to perform an action. Determining, using the user model for the mobile device, that the utterance is indicative of an inability to cause the mobile device to perform an action may include determining that the utterance comprises predetermined voice intonations or speech patterns consistent with user frustration using the user model. Determining that the user of the mobile device is having difficulty causing the mobile device to perform an action may include receiving multiple inputs from a touch screen display included in the mobile device, determining that the multiple inputs each indicate an attempt to cause the mobile device to perform the same action, and determining, using a user model for the mobile device, that the multiple inputs are indicative of an inability to cause the mobile device to perform an action. Determining that the multiple inputs each indicate an attempt to cause the mobile device to perform the same action may include determining that a pressure on the touch screen display of each of the multiple inputs exceeds a threshold pressure.

In some implementations, determining that the user of the mobile device is having difficulty causing the mobile device to perform an action may include receiving input from a touch screen display included in the mobile device, determining that a pressure of the input on the touch screen display exceeds a threshold pressure, and determining, using a user model for the mobile device, that the pressure of the input is indicative of an inability to cause the mobile device to perform an action. Determining that the user of the mobile device is having difficulty causing the mobile device to perform an action may include receiving input from an accelerometer included in the mobile device, and determining that the input indicates frequent or large accelerometer variations and, using a user model for the mobile device, is indicative of an inability to cause the mobile device to perform an action. Determining that the user of the mobile device is having difficulty causing the mobile device to perform an action may include receiving an image of the user from a camera included in the mobile device, and determining, using a user model for the mobile device, that a facial expression of the user represented by the image is indicative of an inability to cause the mobile device to perform an action. Determining that the user of the mobile device is having difficulty causing the mobile device to perform an action may include receiving, from the mobile device, input representing multiple interactions by the user with one or more menus of the mobile device, and determining, using a user model for the mobile device, that the input is indicative of an inability to cause the mobile device to perform an action.

In some implementations, determining the action the user is trying to cause the mobile device to perform may include generating data that causes the mobile device to prompt the user to identify the action the user is trying to cause the mobile device to perform. Generating assistance data to cause the mobile device to perform the action may include selecting a script that specifies one or more actions that correspond with performing the action, and generating, using the script, data to cause a presentation to the user describing the one or more actions that correspond with performing the action.

In some implementations, generating assistance data to cause the mobile device to perform the action may include determining one or more settings recently changed by the user, and generating data to cause a presentation to the user listing the one or more settings. Determining the action the user is trying to cause the mobile device to perform may include determining that the user is trying to cause a particular application executing on the mobile device to perform the action. Determining the one or more settings recently changed by the user may include determining the one or more settings for the particular application. The particular application may be an operating system of the mobile device. Determining the one or more settings recently changed by the user may include determining that the user changed the one or more settings during a predetermined period of time. Determining that the user changed the one or more settings during the predetermined period of time may include determining that the user changed the one or more settings in the past week.

In some implementations, determining the action the user is trying to cause the mobile device to perform may include determining that the user is trying to cause an application on the mobile device to perform the action using a user interface of the application. Generating assistance data to cause the mobile device to perform the action may include causing the application to perform an action that corresponds with a menu option for the user interface. Determining the action the user is trying to cause the mobile device to perform may include determining that the user is trying to cause the mobile device to select the menu option in the user interface. Determining the action the user is trying to cause the mobile device to perform may include determining that input received from the user may be a selection of either of two adjacent menu options from the multiple menu options presented in the user interface.

In some implementations, determining the action the user is trying to cause the mobile device to perform may include determining the action the user is trying to cause the mobile device to perform using an application state of the mobile device. Determining the action the user is trying to cause the mobile device to perform may include determining the action the user is trying to cause the mobile device to perform using an utterance included in an audio signal received by one of the sensors. Determining the action the user is trying to cause the mobile device to perform may include determining the action the user is trying to cause the mobile device to perform using a pattern of activity of the user.

In some implementations, the method may include updating a user model of frustration behavior in response to determining that the user of the mobile device is having difficulty causing the mobile device to perform an action. The method may include determining that the user is a particular type of user. The user model of frustration behavior may include a user model of frustration behavior for the particular type of user.

The subject matter described in this specification can be implemented in particular embodiments so as to realize one or more of the following advantages. In some implementations, a system may determine an action a user is unable to cause a mobile device to perform and, in response, may help the user to cause a mobile device to perform an action. This may leads to a better user experience.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example environment in which an agent assists a user in causing a mobile device to perform an action.

FIG. 2 is an example environment in which an agent provides a user with a list of recently changed settings.

FIG. 3 is an example environment in which an agent assists a user in selecting a menu option.

FIG. 4 is an example system in which assistance data is provided to a user of a mobile device.

FIG. 5 is a flow diagram of a process for generating assistance data.

FIG. 6 is a block diagram of a computing system that can be used in connection with computer-implemented methods described in this document.

Like reference numbers and designations in the various drawings indicate like elements.

### DETAILED DESCRIPTION

### Overview

A computer-implemented agent, or another application or part of an application, on a mobile device may determine a source of a user's frustration based on user interaction with the mobile device, learn from the user interaction with the mobile device, and assist the user in accomplishing a task on the mobile device. For example, the computer-implemented agent may be integrated into a particular application, e.g., an office suite application, executing on the mobile device and the user may be having difficulty causing that particular application to perform the task.

In one example, the computer-implemented agent receives signals from the mobile device's sensors, e.g., an accelerometer, compass, global positioning system (GPS) location, microphone, touch screen, and/or camera, and uses the signals to determine whether the user is having difficulty causing the mobile device to perform a task. For instance, the computer-implemented agent may determine that the signals indicate repeated performance the same action, forceful touch screen interaction, frustrated voice intonations or speech patterns, exploration of menu options, frequent or large accelerometer variations, frustrated facial expressions, or a combination of any two or more of these.

The computer-implemented agent may use the signals to produce a confidence score that represents a probability of whether or not the user is unable to cause the mobile device, e.g., the particular application, to perform a task. The computer-implemented agent may use a user model, created based on interactions with and input from multiple users, and potentially customized for the particular user of the mobile device, to produce the confidence score.

When the confidence score satisfies a threshold value, the computer-implemented agent attempts to determine a source of the user's frustration, e.g., a task the user is trying to cause the mobile device to perform. The computer-implemented agent may use a state of the particular application, a state of the mobile device, a state of a display of the mobile device, utterances spoken by the user, a pattern activity performed by the user, or a combination of any two or more of these to determine the source of the user's frustration. For instance, the user model or another model may classify certain signals as indicative of particular tasks a user may be trying to cause the mobile device to perform.

If the computer-implemented agent is unable to determine the source of the user's frustration using the user model or the other model, the agent may prompt the user for identification of the source of the user's frustration. For instance, the computer-implemented agent may provide the user with an audible prompt, a visual prompt, or both, to ask if the user needs assistance.

When the user indicates that she does not need assistance, the computer-implemented agent logs the combination of signals received from the sensors as a negative training example. The computer-implemented agent, or another application such as a learning module, may adjust the user model, e.g., a general user model, a user model specific to that particular user, or both, using the negative training examples, and positive training examples described below. The computer-implemented agent may use the updated model for later interactions with the user to determine whether or not the user is unable to cause the mobile device to perform a task and may be frustrated.

When the user indicates that she needs assistance, e.g., and is frustrated, and indicates the task the user is trying to cause the mobile device to perform, the computer-implemented agent logs the signals and the task as a positive training example. When a computer-implemented agent later receives the same sequence of signals and/or measurements that are associated with the positive training example, the computer-implemented agent may determine a higher confidence score, e.g., for a particular task that the user may be trying to cause a mobile device to perform.

Upon determining a source of the user's frustration, the computer-implemented agent may use a script or other assistance data to assist the user in causing the mobile device to perform the task. For instance, the computer-implemented agent may provide the user with a uniform resource identifier for a page that describes how to perform the task or a video describing how to accomplish the task. In some examples, the computer-implemented agent may provide the user with directions on how to perform the task, e.g., audibly, may automatically cause the mobile device to perform an action based on the task, or both.

### Example Operating Environments

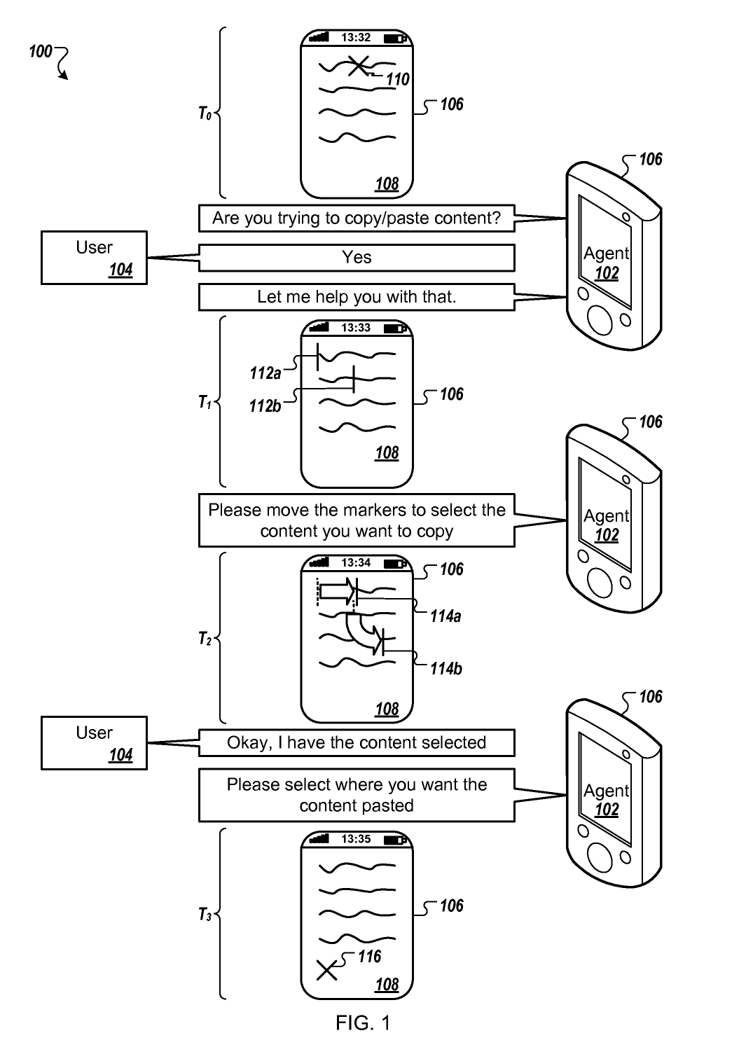

FIG. 1 is an example environment 100 in which an agent 102 assists a user 104 in causing a mobile device 106 to perform an action. At time T₀, the agent 102, e.g., a computer-implemented agent executing on the mobile device 106, detects repeated selection of a portion 110 of a user interface 108 presented on the mobile device 106. The agent 102 determines, based on the repeated selection of the portion 110, that the user 104 may be trying to select text presented near the portion 110, e.g., to cause the mobile device 106 to perform a copy/paste action. The agent 102 may use any appropriate method to determine the action the user 104 is trying to cause the mobile device 106 to perform, such as by using a user model described in more detail below.

The agent 102 may ask the user 104 “are you trying to copy/paste content?” to confirm the action that the user 104 is trying to cause the mobile device 106 to perform and receive a response “yes” from the user 104. The agent 102 may then inform the user 104 that the agent 102 will help the user 104 with the copy/paste action, e.g., by stating “let me help you with that.”

For instance, the agent 102 may provide the user 104 with instructions about how to perform a copy/paste action for the application presented in the user interface 108. In some examples, the agent 102 places two markers 112a-b in the user interface 108, e.g., based on the selected portion 110 of the user interface 108, at time T₁ and informs the user 104 to “move the markers to select the content you want to copy,” as shown in FIG. 1. In some examples, the agent 102 may ask the user 104 to verbally identify the content the user 104 would like to copy/paste or move, e.g., by providing the agent 102 with verbal input identifying a beginning and an ending of a paragraph, sentence, block of text, or other content presented in the user interface 108.

At time T₂, the user 104 moves the markers 112a-b to new marker locations 114a-b. The user 104 may inform the agent 102 that the markers 112a-b are in the correct position, e.g., by saying “okay, I have the content selected.” In some examples, the agent 102 may determine that the user 104 selected the content the user 104 wants to copy when the markers 112a-b have not been moved for a predetermined period of time or when the mobile device 106 has not received touch input, e.g., in the user interface 108, for a predetermined period of time.

The agent 102 prompts the user 104 to “please select where you want the content pasted.” At time T₃, the mobile device 106 receives a selection from the user 104 at another position 116 that identifies a location in the user interface 108 where the selected content should be pasted. The agent 102 pastes the selected content, identified by the new marker locations 114a-b, at the other position 116 in the user interface 108. The agent 102 may confirm that the content was pasted correctly. The agent 102 may ask the user 104 whether the user 104 would like additional assistance.

In some implementations, the agent 102 may prompt the user 104 to determine which of the different actions the user 104 is trying to cause the mobile device 106 to perform. For example, the agent 102 may prompt the user 104 to determine whether the user 104 is trying to cause the mobile device 106 to perform a “copy/paste” action or a “cut/paste” action, e.g., to move content presented in the user interface 108. Upon determining the action or actions the user 104 is trying to cause the mobile device 106 to perform, the agent 102 may identify corresponding scripts and walk the user 104 through one or more steps, specified by the scripts, that will allow the user 104 to cause the mobile device 106 to perform the action.

The agent 102 may have a script for each action with which the agent 102 may assist the user 104. Some example actions may include sending an email, sending a text message, taking a picture, installing an application, setting a password, or otherwise interacting with an application.

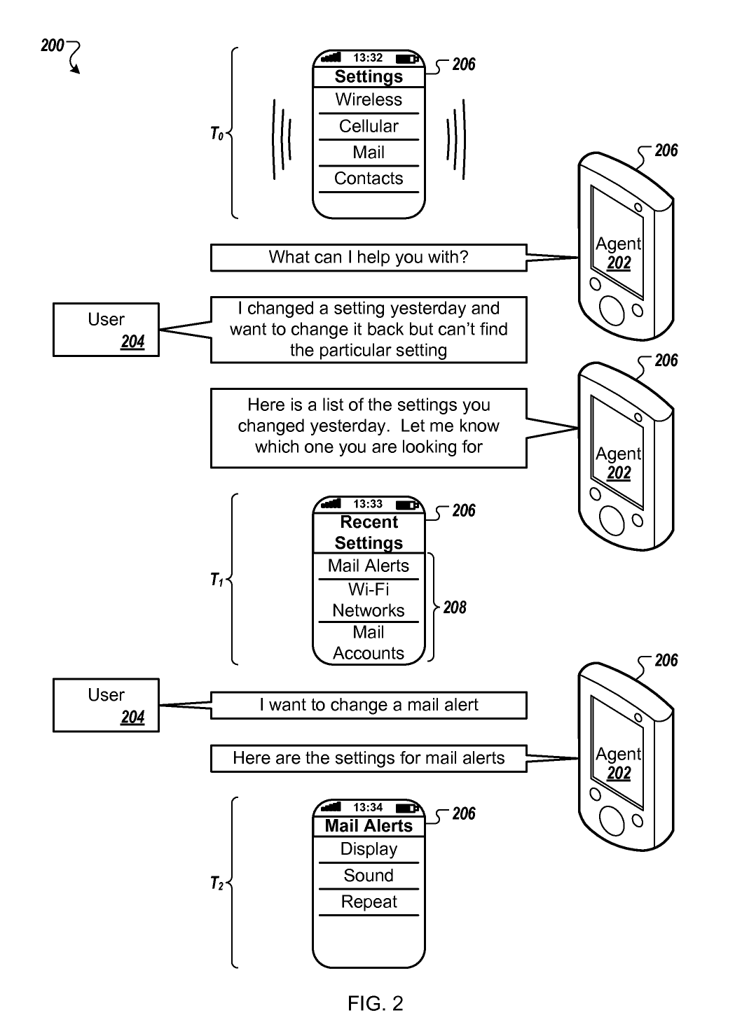

FIG. 2 is an example environment 200 in which an agent 202 provides a user 204 with a list of recently changed settings. At time T₀, the agent 202 may determine that the user 204 is shaking a mobile device 206, on which the computer-implemented agent 202 executes or with which the agent 202 is associated, and prompt the user 204 “what can I help you with?” The agent 202 may receive audible input from the user 204 indicating that the user “changed a setting yesterday and wants to change it back but can't find the particular setting.”

The agent 202 finds a log of settings recently changed by the user 204, e.g., when the mobile device 206 logs setting changes, and determines the settings that were changed yesterday. The agent 202 informs the user 204 that “here is a list of settings you changed yesterday. Let me know which one you are looking for” and presents, on a display of the mobile device 206, a list 208 that identifies the settings that were changed yesterday. In some examples, the agent 202 may present the list of settings that were changed yesterday audibly instead of, or in addition to, presenting the list 208 on the display of the mobile device 206. The list 208 may indicate that settings for mail alerts, Wi-Fi networks, and mail accounts were changed yesterday.

The agent 202 may then receive input from the user 204 indicating that the user “wants to change a mail alert” and inform the user that “here are the settings for mail alerts.” At time T₂, the agent 202 presents the settings for the mail alerts, such as a display, a sound, and a repeat setting, on the display of the mobile device 206. The presented settings may include all settings for mail alerts or only those settings that were changed by the user 204 yesterday.

In some implementations, when the mobile device 206 has more than one user, the agent 202 may identify only the settings that were changed by the particular user who is operating the mobile device 206 and interacting with the agent 202. In other implementations, the agent 202 may identify settings that were changed by any of the users of the mobile device 206.

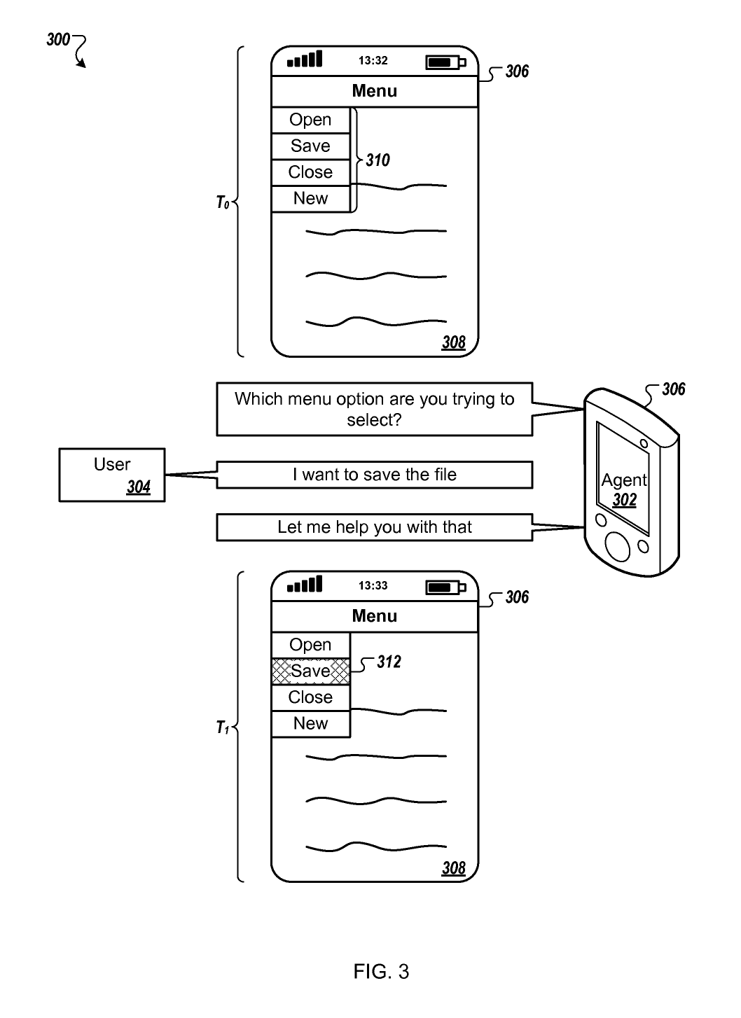

FIG. 3 is an example environment 300 in which an agent 302 assists a user 304 in selecting a menu option. At time T₀, the agent 302, e.g., a computer-implemented agent on a mobile device 306, may determine that the user 304 is having difficulty selecting one of multiple menu options 310 presented in a user interface 308 on the mobile device 306. For instance, the menu options 310 may be designed for presentation on a display larger than a display included on the mobile device 306 and may be small or otherwise difficult to select when presented on the mobile device 306.

The agent 302 may prompt the user 304 “which menu option are you trying to select?” and receive input, e.g., audibly, from the user 304 indicating that the user 304 “wants to save the file.” The agent 302 may inform the user 304 that the agent 302 will help the user 304 save the file, e.g., by saying “let me help you with that,” and, at time T₁, the agent 302 selects a save option 312 from the multiple menu options 310.

### Example System

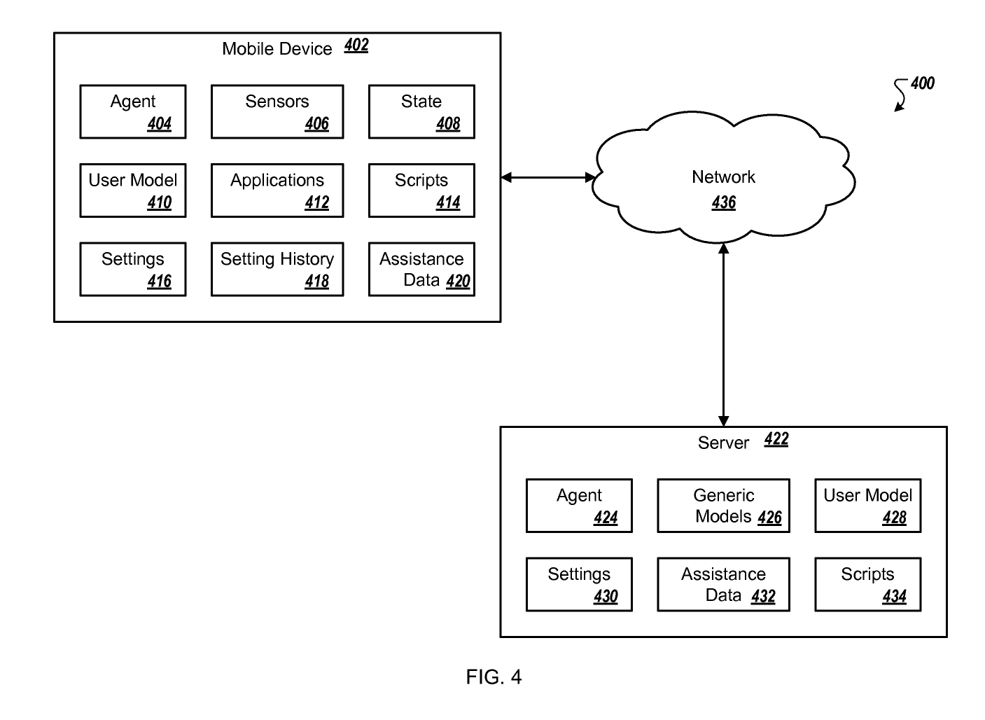

FIG. 4 is an example system 400 in which assistance data is provided to a user of a mobile device 402. A computer-implemented agent 404, executing on the mobile device 402 and associated with the mobile device 402 or an application 412 executing on the mobile device, receives output from one or more sensors 406 and a state 408, e.g., of the mobile device 402, an application executing on the mobile device 402, or both. The agent 404 uses the output from the sensors 406 and the state 408 with a user model 410, e.g., specific to a user of the mobile device 402, to determine whether the user is having difficulty causing the mobile device 402 to perform an action. For instance, the agent 404 may use the output from the sensors 406 and the state 408 as input to the user model 410 to generate a confidence score that represents whether or not the user is having difficulty. The user model 410 may use artificial intelligence, or any other appropriate algorithm, to determine the confidence score based on past positive and negative training examples.

If the confidence score satisfies a threshold value, e.g., is greater than the threshold value, the agent 404 determines that the user is likely having difficulty. If the confidence score does not satisfy the threshold value, e.g., is equal to or less than the threshold value, the agent 404 determines that the user is not likely having difficulty.

The user model 410 may be specific to the user operating the mobile device 402. The user model 410 may be generated using data from multiple users. For example, a generic user model, e.g., generic models 426, may be created using data, e.g., positive training examples, negative training examples, or both, from multiple users, e.g., to determine behaviors that typically represent user frustration. The agent 404 may customize a generic user model for the user of the mobile device 402, based on interactions with the user.

For instance, a generic user model may indicate that hard tapping on a display of the mobile device 402, e.g., five times, followed by shaking of the mobile device 402 indicates a high probability that the user is having difficulty causing the mobile device 402 to perform a particular action. A user model specific to the user of the mobile device 402 may indicate that hard tapping on the display, e.g., ten times, followed by shaking of the mobile device 402 indicates a high probability that the user is having difficulty, e.g., as the user may frequently apply hard pressure to the display. Over time a generic model may be modified for a particular user so that it is customized for the user.

The sensors 406 may include one or more of location sensors, e.g., GPS sensors, cellular sensors, Bluetooth sensors, or Wi-Fi sensors; an accelerometer; a gyroscope; a compass; a camera; a touch screen; or a microphone. An accelerometer and a gyroscope may be used to detect movement of the mobile device 402, such as if the user may be shaking the mobile device, e.g., represented by frequent and/or large accelerometer variations. The agent 404 may use an image from the camera to detect facial features of the user, such as whether the user has an expression that is associated with anger or frustration as determined with the user model 410. The microphone may receive utterances spoken by the user, such as “why won't this work?” or “where is that setting I changed yesterday.” The agent 404 may convert the utterances to text and, using the user model 410, may compare the text to text specified in the user model that indicates verbal signals of user frustration or inability to cause a user device to perform an action. The agent 404 may use data that represents a voice intonation and/or speech patterns and compare the data with a user model to determine whether the utterance has a predetermined voice intonation and/or speech pattern that is consistent with user frustration and/or an inability to cause the mobile device 402 to perform an action.

The agent 404 uses input from the sensors 406 with the user model 410 to determine whether the input is indicative of user inability to cause a mobile device to perform an action. For instance, the agent 404 determines whether movement represented by input from an accelerometer, a facial expression in an image, a voice intonation, a speech pattern, or a combination of two or more inputs from the sensors 406 are indicative of an inability to cause a mobile device to perform an action. In some examples, the user model 410 may indicate that two or more inputs, from different sensors, are necessary to determine an inability to cause the mobile device to perform an action.

When the state 408 includes information about an application executing on the mobile device 402, the state 408 may include information about a current user interface of the application, a file currently accessed by the application, an open menu of the application, or a dialog box presented in the user interface. When the state 408 includes information about the mobile device 402, the state 408 may include a list of the applications that are currently executing, in the foreground, background, or both, the wireless antennas that are connected to another device, whether the mobile device 402 has a cellular connection, the time of day, the day of the week, whether the mobile device 402 is locked or not, applications installed on the mobile device 402 but not currently executing, or any combination of two or more of these.

Upon determining that the user is having difficulty causing the mobile device 402 to perform an action, e.g., when the confidence score generated using the user model 410 satisfies the threshold value, the agent 404 may identify a script 414 or other assistance data 420 to help the user cause the mobile device 402 to perform the action. For example, the user model 410, or another user model, may use the output from the sensors 406, the state 408, or both, as input to determine the action the user is likely trying to cause the mobile device 402 to perform. When the agent 404 uses the user model 410 to determine the action, the agent 404 may determine both the confidence score and the action at substantially the same time, e.g., in response to providing the output from the sensors 406 and the state 408 to the user model 410.

In some examples, the agent 404 may use the user model 410 to determine multiple actions the user is likely trying to cause the mobile device 402 to perform and a corresponding probability score for each of the different actions. The probability score represents a probability that the user is trying to cause the mobile device to perform the corresponding action and may be generated using a user model that correlates data about users, e.g., input received by the sensors 406, with actions the users were trying to cause corresponding mobile devices to perform.

The agent 404 may select the action with the greatest probability and assist the user in causing the mobile device 402 to perform that action. In some examples, the agent 404 may select a subset of the actions and prompt the user, e.g., visually or audibly, to determine which action from the subset of the actions the user is trying to cause the mobile device 402 to perform.

In some implementations, when the probability score does not satisfy a threshold probability, e.g., is less than the threshold probability, the agent 404 may prompt the user to determine the action. For example, the agent 404 may ask the user “what can I help you with?”

Each of the scripts 414 may be associated with a different action. Upon determining an action that the user is trying to cause the mobile device 402 to perform, the agent 404 determines the corresponding script from the scripts 414. Some of the scripts may be associated with multiple actions. For instance, the same script may be associated with a “copy/paste” action and a “cut/paste” action and identify a different subsequence of steps for the agent 404 to perform depending on the particular action, e.g., copying the content versus moving the content.

The assistance data 420 may include links to information about actions, videos, audio files, help documents, and other data that may be presented to a user. In some implementations, the agent 404 may identify a script for an action the user is trying to cause the mobile device 402 to perform and the script may indicate particular assistance data 420 for the agent 404 to use when helping the user.

The mobile device 402 includes multiple settings 416, for an operating system of the mobile device 402, one or more of the applications 412 of the mobile device, or a combination of the two. When an operator of the mobile device 402 changes one of the settings 416, the mobile device 402 may update a setting history 418 that identifies the particular settings 416 that were changed, and optionally the previous setting value, e.g., which the agent 404 may provide to the user when the user wants to change the setting back to its previous value.

The setting history 418 may include one entry for each of the settings 416. For instance, when a user changes a Wi-Fi password for their home network on Monday, and again changes the password on Thursday, the setting history 418 may include only one entry that indicates that the Wi-Fi password for her home network was changed instead of two entries. In some examples, the setting history 418 may include information about all setting changes, whether or not the changes are for the same setting. The setting history 418 may be time limited such that entries older than a predetermined age are discarded from the setting history 418, e.g., changes made more than three or four months ago.

In some implementations, the agent 404 is for the mobile device 402. In other implementations, the agent 404 is specific to a particular application. For example, the agent may be a module of the particular application. In these implementations, when that particular application is the or one of the active applications on the mobile device 402, e.g., and presents content on a display of the mobile device 402, the agent 404 may use output from the sensors 406 to determine whether a user is having difficulty causing the application to perform an action and does not analyze the output from the sensors 406 when that particular application is not active, e.g., and is running in the background.

The mobile device 402 may include multiple agents, e.g., one for the mobile device 402 and one or more that are each specific to a particular application installed on the mobile device 402. In these implementations, a single agent, e.g., specific to the mobile device 402, may determine whether the user is having difficulty causing the mobile device 402 to perform an action. Upon determining that the user is having difficulty causing the mobile device 402 to perform an action, the single agent may alert other agents, e.g., each of which is associated with a currently active application on the mobile device 402, and the single agent and the other agents may each determine whether the action is for a corresponding application with which the respective agent is associated.

In some examples, the agent 404 executes on a server 422, as a computer-implemented agent 424, and is associated with the mobile device 402. For instance, the server 422 may associate the agent 424 with the mobile device 402 using an identifier for the mobile device 402.

The server 422 may periodically receive output from the sensors 406 and provide the output to the agent 424. The agent 424 uses the output from the sensors 406 and a user model 428, specific to a user of the mobile device 402, to determine a confidence score that represents whether or not the user is having difficulty causing the mobile device 402 to perform an action.

The user model 428 may be one of the generic models 426 that are trained for different types of users. For example, the agent 424 may receive input indicating that the user of the mobile device 402 is a jogger and identify one of the generic models 426 that has been trained using data from multiple joggers. This model may indicate that the mobile device 402 is often shaken during predetermined periods of time, e.g., when the user goes jogging, and may be customized for the particular user. For instance, the particular user may go jogging in the morning, e.g., between 8 AM and 10 AM, and the server 422 may store data associating the mobile device 402 with the generic jogger user model and the predetermined period of time, e.g., between 8 AM and 10 AM, as the user model 428. When the agent 424 detects shaking of the mobile device 402 between 8 AM and 10 AM, the agent 424 may determine that the user is not having difficulty causing the mobile device 402 to perform an action. When the agent 424 detects shaking of the mobile device 402 during a different time period, the agent 424 may determine that the user is having difficulty causing the mobile device 402 to perform an action.

The server 422 may include one or more settings 430, of the mobile device 402, the applications 412, for the user of the mobile device 402, or a combination of any two or more of these. Settings specific to the user of the mobile device 402 may indicate that the agent 424 should not determine whether the user is having difficulty causing the mobile device 402 to perform an action during the night, how frequently the agent 424 should analyze data from the sensors 406, e.g., which may be specific to a type of a network 436 over which the mobile device 402 communicates with the server 422, or the types of sensors from which the agent 424 should receive data, to name a few examples.

The server 422 may include assistance data 432 and scripts 434 similar to the assistance data 420 and the scripts 414, respectively, that may be stored on the mobile device 402. For instance, when the agent 404 executes on the mobile device 402, the agent 404 may request a particular script or particular assistance data from the server 422, e.g., when the particular script or the particular assistance data is not stored on the mobile device 402 or when no scripts and/or assistance data are stored on the mobile device 402.

The mobile device 402 may include smart phones, feature phones, tablets, and other mobile devices that can send and receive data over the network 436 and detect potential user frustration. The network 436, such as a local area network (LAN), wide area network (WAN), the Internet, or a combination thereof, connects the mobile device 402 and the server 422.

### Example Process Flow

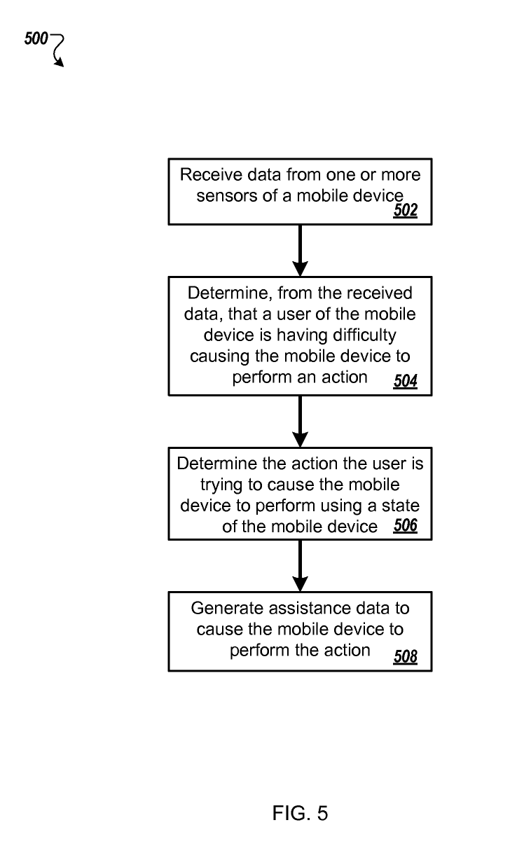

FIG. 5 is a flow diagram of a process 500 for generating assistance data. For example, the process 500 can be used by the agent 404 or the agent 424 from the system 400.

The process receives data from one or more sensors of a mobile device (502). For instance, a computer-implemented agent executing on a server may request data from the sensors and, in response, receive the requested data from the sensors. The request may be performed according to a schedule, e.g., predetermined by an administrator or by the user of the mobile device. For example, the agent may request the data about every second or about every ten seconds, e.g., when the mobile device is not locked.

The agent may passively monitor input to determine patterns that indicate that the user may need, or could benefit from, assistance, e.g., and may be having difficulty causing the mobile device to perform an action. A pattern may include a particular combination of input from mobile device sensors, e.g., accelerometers or microphones, one or more currently active applications, e.g., a browser, email application, or photograph application, a particular time or period of day, e.g., during work hours, a particular day of week, e.g., on weekends, etc.

In some examples, an agent, e.g., executing on the mobile device, may receive input from the sensors and process the input, e.g., when the sensors have input to provide to the agent. For instance, an accelerometer may provide the agent with data only when the mobile device is moving.

The agent compares the data from the sensors with the patterns to determine whether the data matches one of the patterns, e.g., specified by a user or administrator or learned. For instance, the agent may learn one or more patterns based on feedback from a user. When the agent determines that the data matches at least one of the patterns, the agent may determine that the user is having difficulty causing the mobile device to perform an action.

The process determines, from the received data, that a user of the mobile device is having difficulty causing the mobile device to perform an action (504). For example, the computer-implemented agent determines that a confidence score, generated using a user model that takes the received data as input, satisfies a threshold value. The user model may be specific to the user or generic based on a type of the user. For instance, a system may include different generic user models for joggers, baseball players, skaters, skiers, wake boarders, etc. and the agent may select the generic model that corresponds the most with the user. The agent may prompt the user to select the type of user, during the process 500 or prior to performing the process 500.

In some examples, the agent may receive an update to the type of user from the user or automatically, e.g., based on a calendar appointment of the user. For example, when the user goes on vacation in the Alps, the agent may change the user type from jogger to skier, e.g., when the user typically goes jogging outside every morning. The agent may change the user model multiple times during a single day depending on input from the user or different calendar appointments for the user.

The agent may ask the user if she is needs assistance and is having difficulty causing the mobile device to perform an action. In some examples, the agent may send a request to a server-side agent, e.g., when the agent executes on the mobile device or a different server, to confirm that the user may be having difficulty causing the mobile device to perform an action or to get additional instructions. For example, in response to the request, the agent receives a message from the server-side agent that confirms whether or not the user is likely having difficulty causing the mobile device to perform an action.

The process determines the action the user is trying to cause the mobile device to perform using a state of the mobile device (506). For instance, the computer-implemented agent uses the state of the mobile device to determine one or more actions the user may be trying to cause the mobile device to perform and corresponding probabilities for each of the actions that indicate a probability that the user is trying to cause the mobile device to perform the corresponding action. In some examples, a sum of the probabilities may be one.

The agent may select the action associated with the highest probability or may prompt the user to select an action, e.g., when multiple actions have the same or similar probabilities. In some examples, when none of the probabilities satisfies a threshold value, the agent may generate data that causes the mobile device to prompt the user for the action the user is trying to cause the mobile device to perform. For instance, an agent executing on a server may generate the data and provide the data to the mobile device. In response, the mobile device provides a prompt to the user asking the user which action she is trying to cause the mobile device to perform.

The process generates assistance data to cause the mobile device to perform the action (508). The agent, e.g., executing on a server, may select a script or other assistance data from a database that is specific to the determined action. When the agent is executing on a server, the agent may provide the selected script to another agent executing on the mobile device or may cause the presentation of the assistance data or other content on the mobile device, e.g., visibly, audibly, or both, to assist the user in causing the mobile device to perform the action. In some examples, the agent may provide instructions, generated using a script or other assistance data, to the mobile device, e.g., an agent on the mobile device. When the agent is executing on the mobile device, the agent may present the assistance data or other content, such as instructions for the user.

The order of steps in the process 500 described above is illustrative only, and generating assistance data can be performed in different orders. For example, the agent may determine the action the user is trying to cause the mobile device to perform, e.g., perform step 506, and then determine that the user of the mobile device is having difficulty causing the mobile device to perform the action, e.g., perform step 504.

In some implementations, the process 500 can include additional steps, fewer steps, or some of the steps can be divided into multiple steps. For example, the determination that the user is having difficulty causing the mobile device to perform the action may be specific to the determined action. For instance, when a menu is presented on a display of the mobile device and the agent determines that the user is shaking the mobile device, e.g., using input from an accelerometer, the agent may determine that the user is having difficulty causing the mobile device to perform an action. When, however, the mobile device is locked, e.g., and the agent does not identify any action the user is trying to cause the mobile device to perform, or presents a text message interface, the agent may determine that the user is shaking the mobile device and that the user is not having difficulty causing the mobile device to perform an action.

### Optional Implementation Details

In some implementations, one or more of the scripts may be specific to a particular application on the mobile device. For example, when the mobile device includes multiple agents, each for a different application, one or more of the agents may have access to scripts for its corresponding application, e.g., which are not accessible to the other agents. In these implementations, the mobile device may include one or more generic scripts accessible by all of the agents, e.g., for actions which may be performed on all or a subset of the applications, such as a script indicating how to close an application. The generic scripts may also include scripts specific to the mobile device, e.g., the operating system of the mobile device.

In some implementations, the agent may receive input from the user identifying a particular menu option for which the user is looking. The agent may search data associated with the mobile device or a corresponding application for the particular menu option, and upon finding the particular menu option, or a menu option that has a probability greater than a threshold probability of being the particular menu option, the agent may present information about the menu option to the user. For instance, when the user requests a “Wi-Fi networks” option and the agent finds a “wireless networks” option, the agent may determine a probability that the “wireless networks” option is the menu option for which the user is looking based on the similarity in the names of the menu options.

In some implementations, the agent, or another module on a server, may update or otherwise change an application in response to repeated user difficulty in causing a mobile device to perform an action. For example, the agent may determine that the user, or a subset of users, frequently have difficulty locating a particular setting in a menu, where those users typically look in the menu for that setting, and move that setting to the location in the menu where those users typically look. The agent may change the version of the application executing on a single mobile device, e.g., the user's mobile device, on the mobile devices for the subset of users, or on all mobile devices.

In some examples, the agent, or another module on a server, may change a sequence of menu options in response to repeated user difficulty causing a mobile device to perform a sequence of actions. For instance, the module may change a process flow for an application.

### Additional Implementation Details

In situations in which the systems or agents discussed here collect personal information about users, or may make use of personal information, the users may be provided with an opportunity to control whether programs or features collect user information (e.g., social activities, a user's preferences, or a user's current location), or to control whether and/or how to receive content from the agent that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by an agent.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

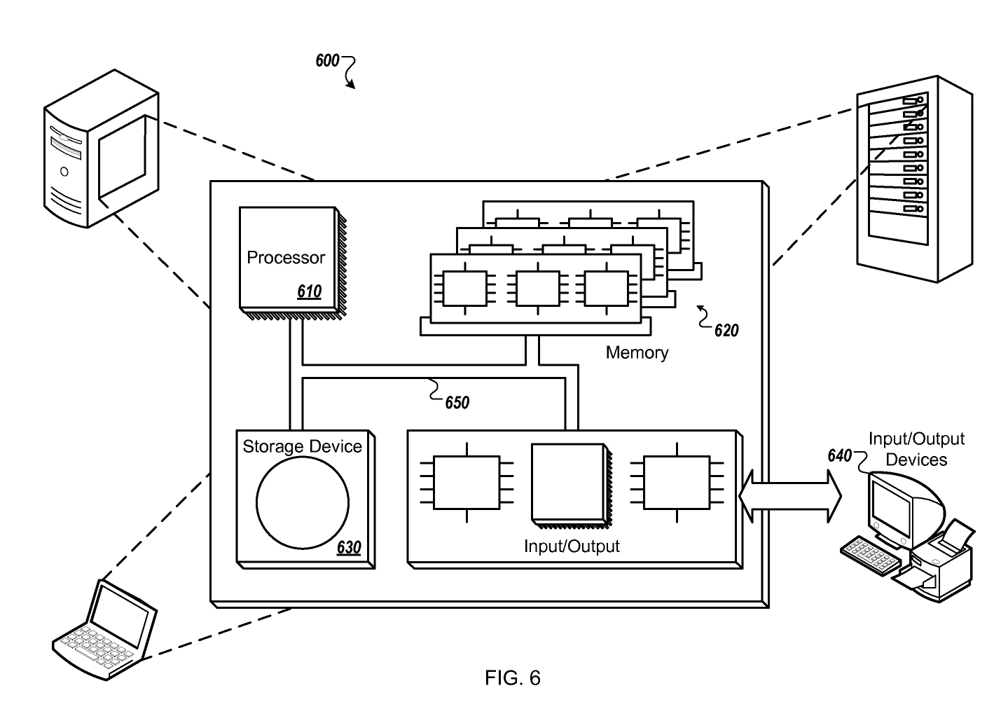

An example of one such type of computer is shown in FIG. 6, which shows a schematic diagram of a generic computer system 600. The system 600 can be used for the operations described in association with any of the computer-implement methods described previously, according to one implementation. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
retrieving, from memory, data for multiple user models that were each trained using training data from multiple users;
receiving first data from at least one of multiple sensors of a mobile device;
associating, based on the received first data, a first user model from the multiple user models with the mobile device;
receiving second data from at least one of the multiple sensors of the mobile device;
determining, using the first user model and the received second data, that a user of the mobile device is having difficulty causing the mobile device to perform a first action;
determining, using the first user model, the first action the user is trying to cause the mobile device to perform using a first state of the mobile device;
generating first assistance data to cause the mobile device to perform the first action;
automatically associating a second user model from the multiple user models with the mobile device including removing the association between the first user model and the mobile device for the user so that only one user model is associated with the mobile device for the user at any particular time after associating the first user model from the multiple user models with the mobile device, wherein the second user model is a different user model than the first user model;
receiving third data from at least one of the multiple sensors of the mobile device;
determining, using the second user model and the received third data, that a user of the mobile device is having difficulty causing the mobile device to perform a second action;
determining, using the second user model, the second action the user is trying to cause the mobile device to perform using a second state of the mobile device;
generating second assistance data to cause the mobile device to perform the second action; and
automatically re-associating the first user model from the multiple user models with the mobile device including removing the association between the second user model and the mobile device for the user so that only one user model is associated with the mobile device for the user at any particular time after generating the second assistance data to cause the mobile device to perform the second action.

2. The method of claim 1 wherein determining that the user of the mobile device is having difficulty causing the mobile device to perform the first action or the second action comprises:
receiving a digital representation of speech encoding an utterance; and
determining, using a user model for the mobile device, that the utterance is indicative of an inability to cause the mobile device to perform an action.

3. The method of claim 2 determining, using the user model for the mobile device, that the utterance is indicative of an inability to cause the mobile device to perform an action comprises determining that the utterance comprises predetermined voice intonations or speech patterns consistent with user frustration using the user model.

4. The method of claim 1 wherein determining that the user of the mobile device is having difficulty causing the mobile device to perform the first action or the second action comprises:
receiving multiple inputs from a touch screen display included in the mobile device;
determining that the multiple inputs each indicate an attempt to cause the mobile device to perform the same action; and
determining, using the first user model for the mobile device, that the multiple inputs are indicative of an inability to cause the mobile device to perform an action.

5. The method of claim 4 wherein determining that the multiple inputs each indicate an attempt to cause the mobile device to perform the same action comprises determining that a pressure on the touch screen display of each of the multiple inputs exceeds a threshold pressure.

6. The method of claim 1 wherein determining that the user of the mobile device is having difficulty causing the mobile device to perform the first action or the second action comprises:
receiving input from an accelerometer included in the mobile device; and
determining that the input indicates frequent or large accelerometer variations and, using the first user model for the mobile device, is indicative of an inability to cause the mobile device to perform an action.

7. The method of claim 1 wherein determining that the user of the mobile device is having difficulty causing the mobile device to perform the first action or the second action comprises:
receiving an image of the user from a camera included in the mobile device; and
determining, using a user model for the mobile device, that a facial expression of the user represented by the image is indicative of an inability to cause the mobile device to perform an action.

8. The method of claim 1 wherein determining that the user of the mobile device is having difficulty causing the mobile device to perform the first action or the second action comprises:
receiving, from the mobile device, input representing multiple interactions by the user with one or more menus of the mobile device; and
determining, using the first user model for the mobile device, that the input is indicative of an inability to cause the mobile device to perform an action.

9. The method of claim 1 wherein determining the first action or determining the second action the user is trying to cause the mobile device to perform comprises generating data that causes the mobile device to prompt the user to identify the action the user is trying to cause the mobile device to perform.

10. The method of claim 1 wherein generating assistance data to cause the mobile device to perform the first action or to cause the mobile device to perform the second action comprises:
selecting a script that specifies one or more actions that correspond with performing the action; and
generating, using the script, data to cause a presentation to the user describing the one or more actions that correspond with performing the action.

11. The method of claim 1 wherein generating assistance data to cause the mobile device to perform the first action or to cause the mobile device to perform the second action comprises:
determining one or more settings recently changed by the user; and
generating data to cause a presentation to the user listing the one or more settings.

12. The method of claim 11 wherein:
determining the first action or determining the second action the user is trying to cause the mobile device to perform comprises determining that the user is trying to cause a particular application executing on the mobile device to perform the action; and
determining the one or more settings recently changed by the user comprises determining the one or more settings for the particular application.

13. The method of claim 12 wherein the particular application is an operating system of the mobile device.

14. The method of claim 11 wherein determining the one or more settings recently changed by the user comprises determining that the user changed the one or more settings during a predetermined period of time.

15. The method of claim 1 wherein:
determining the first action or determining the second action the user is trying to cause the mobile device to perform comprises determining that the user is trying to cause an application on the mobile device to perform the action using a user interface of the application; and
generating first assistance data or generating second assistance data to cause the mobile device to perform the action comprises causing the application to perform an action that corresponds with a menu option for the user interface.

16. The method of claim 15 wherein determining the first action or determining the second action the user is trying to cause the mobile device to perform comprises determining that input received from the user may be a selection of either of two adjacent menu options from multiple menu options presented in the user interface.

17. The method of claim 1 wherein determining the first action or determining the second action the user is trying to cause the mobile device to perform comprises determining the action the user is trying to cause the mobile device to perform using an utterance included in an audio signal received by at least one of the multiple sensors.

18. The method of claim 1 wherein determining the first action or determining the second action the user is trying to cause the mobile device to perform comprises determining the action the user is trying to cause the mobile device to perform using a pattern of activity of the user.

19. A system, comprising:
a data processing apparatus; and
a non-transitory computer readable storage medium in data communication with the data processing apparatus and storing instructions executable by the data processing apparatus and upon such execution cause the data processing apparatus to perform operations comprising:
retrieving, from memory, data for multiple user models that were each trained using training data from multiple users;
receiving first data from at least one of multiple sensors of a mobile device;
associating, based on the received first data, a first user model from the multiple user models with the mobile device;
receiving second data from at least one of the multiple sensors of the mobile device;
determining, using the first user model and the received second data, that a user of the mobile device is having difficulty causing the mobile device to perform a first action;
determining, using the first user model, the first action the user is trying to cause the mobile device to perform using a first state of the mobile device;
generating first assistance data to cause the mobile device to perform the first action;
automatically associating a second user model from the multiple user models with the mobile device including removing the association between the first user model and the mobile device for the user so that only one user model is associated with the mobile device for the user at any particular time after associating the first user model from the multiple user models with the mobile device, wherein the second user model is a different user model than the first user model;
receiving third data from at least one of the multiple sensors of the mobile device;
determining, using the second user model and the received third data, that a user of the mobile device is having difficulty causing the mobile device to perform a second action;
determining, using the second user model, the second action the user is trying to cause the mobile device to perform using a second state of the mobile device;
generating second assistance data to cause the mobile device to perform the second action; and
automatically re-associating the first user model from the multiple user models with the mobile device including removing the association between the second user model and the mobile device for the user so that only one user model is associated with the mobile device for the user at any particular time after generating the second assistance data to cause the mobile device to perform the second action.

20. A non-transitory computer readable storage medium storing instructions executable by a data processing apparatus and upon such execution cause the data processing apparatus to perform operations comprising:
retrieving, from memory, data for multiple user models that were each trained using training data from multiple users;
receiving first data from at least one of multiple sensors of a mobile device;
associating, based on the received first data, a first user model from the multiple user models with the mobile device;
receiving second data from at least one of the multiple sensors of the mobile device;
determining, using the first user model and the received second data, that the user of the mobile device is having difficulty causing the mobile device to perform a first action;
determining, using the first user model, the first action the user is trying to cause the mobile device to perform using a first state of the mobile device;
generating first assistance data to cause the mobile device to perform the first action;
automatically associating a second user model from the multiple user models with the mobile device including removing the association between the first user model and the mobile device for the user so that only one user model is associated with the mobile device for the user at any particular time after associating the first user model from the multiple user models with the mobile device, wherein the second user model is a different user model than the first user model;
receiving third data from at least one of the multiple sensors of the mobile device;
determining, using the second user model and the received third data, that a user of the mobile device is having difficulty causing the mobile device to perform a second action;
determining, using the second user model, the second action the user is trying to cause the mobile device to perform using a second state of the mobile device;
generating second assistance data to cause the mobile device to perform the second action; and
automatically re-associating the first user model from the multiple user models with the mobile device including removing the association between the second user model and the mobile device for the user so that only one user model is associated with the mobile device for the user at any particular time after generating the second assistance data to cause the mobile device to perform the second action.

21. The method of claim 1, comprising generating the multiple user models using training data of multiple users.

22. The method of claim 21, wherein generating the multiple user models using the training data of multiple users comprises:
receiving respective data representing interactions of multiple other users with respective mobile devices;
determining whether the respective data satisfies a confidence threshold, wherein the confidence threshold is satisfied when the respective data indicates that a user from the multiple users is having difficulty causing the respective mobile device to perform an action; and
classifying, based on determining whether the respective data satisfies the confidence threshold, the respective data into (i) positive training examples that indicate the user is having difficulty causing the respective mobile device to perform the action and (ii) negative training examples that indicate the user is not having difficulty causing the respective mobile device to perform the action.

23. The method of claim 1, comprising receiving each of the multiple user models that were trained using training data representing interactions of multiple other users with respective mobile devices, wherein, for each of the user models, the training data was classified into positive training examples in response to a determination whether the training data satisfies a confidence threshold, wherein the confidence threshold is satisfied when data indicates that a respective user from the multiple users is having difficulty causing the respective mobile device to perform an action.

24. The method of claim 1, wherein associating the first user model from the multiple user models with the mobile device comprises:
determining, using the received first data, a type of the user of the mobile device;
identifying, using the type of the user of the mobile device, the first user model from the multiple user models; and
associating the first user model from the multiple user models with the mobile device in response to identifying the first user model from the multiple user models.

25. The method of claim 1, wherein associating the first user model from the multiple user models with the mobile device comprises:
determining characteristics of the user of the mobile device;
identifying, using the determined characteristics of the user of the mobile device, the first user model from the multiple user models; and
associating the first user model from the multiple user models with the mobile device in response to identifying the first user model from the multiple user models.

26. The method of claim 1, wherein associating the first user model from the multiple user models with the mobile device comprises:
determining a time of day during which the first data is received from the at least one of the multiple sensors;
identifying, using the determined time of day during which the first data is received from the at least one of the multiple sensors, the first user model from the multiple user models; and
associating the first user model from the multiple user models with the mobile device in response to identifying the first user model from the multiple user models.

27. The method of claim 1, wherein automatically associating the second user model with the mobile device occurs after generating the first assistance data to cause the mobile device to perform the first action.

28. The method of claim 1, wherein receiving the second data from at least one of the multiple sensors of the mobile device occurs after re-associating the first user model from the multiple user models with the mobile device.

29. The method of claim 1, wherein automatically associating the second user model from the multiple user models with the mobile device comprises automatically associating, based on a change from a first context to a second context, the second user model from the multiple user models with the mobile device.

30. The method of claim 29, wherein automatically associating, based on a change from the first context to the second context, the second user model from the multiple user models with the mobile device comprises automatically associating, based on a calendar appointment for the user, the second user model from the multiple user models with the mobile device.

31. The method of claim 29, wherein automatically associating, based on a change from the first context to the second context, the second user model from the multiple user models with the mobile device comprises automatically associating the second user model from the multiple user models with the mobile device for a predetermined period of time during which the second context applies.

32. (canceled)

33. The system of claim 19, wherein associating the first user model from the multiple user models with the mobile device comprises:
determining a time of day during which the first data is received from the at least one of the multiple sensors;
identifying, using the determined time of day during which the first data is received from the at least one of the multiple sensors, the first user model from the multiple user models; and
associating the first user model from the multiple user models with the mobile device in response to identifying the first user model from the multiple user models.
